(19) United States
(12) Patent Application Publication
(10) Pub. No.: US 2013/0074779 A1
(43) Pub. Date: Mar. 28, 2013

(54) PET CHEW TOY

(71) Applicant: YI CHIH LIN, Chiayi County (TW)

(72) Inventor: YI CHIH LIN, Chiayi County (TW)

(21) Appl. No.: 13/244,357

(22) Filed: Sep. 24, 2011

(51) Int. Cl. A01K 29/00

(52) U.S. Cl. 119/710

(57) ABSTRACT

A pet chew toy contains a body including a cowskin layer rolled and having an external fill space and an internal fill space; a filing member including a fluidic ground meat with a number of granule-shaped meat balls, characterized in that: the external fill space of the body includes the fluidic ground meat filled or applied therein.

### BACKGROUND OF THE INVENTION

1. Field of the Invention

The present invention relates to a pet chew toy contains a cowskin layer rolled and having an external fill space and an internal fill space, the external fill space of the body includes the fluidic ground meat filled or applied therein to present variety.

2. Description of the Prior Art

A conventional pet chew toy is made by grinding various raw materials together or making of a single raw material.

Nevertheless, the various materials are mixed together that can not attract a pet.

The pet chew toy is made of the single raw material to lose mouthfeel and aroma.

The filler is mixed from various materials that can not present variety.

However, such a conventional pet chew toy structure still has the following disadvantages:

1. The various raw materials are mixed together that can not attract the pet's appetite.

2. The single raw material is dull that can not enhance delicious taste of the pet chew toy.

3. The pet chew toy structure can not be made in a vivid appearance and layer manner because the various raw materials are mixed and ground together to have a messy appearance.

The present invention has arisen to mitigate and/or obviate the afore-described disadvantages.

### SUMMARY OF THE INVENTION

The primary object of the present invention is to provide a pet chew toy that includes various structural layers to enhance a pet's appetite.

Secondary object of the present invention is to provide a pet chew toy that includes various materials to obtain mouthfeel and aroma. Third object of the present invention is to provide a pet chew toy that includes a cowskin layer in which a fluidic ground meat with a number of granule-shaped meat balls to attract the sense of smell of the pet.

Fourth object of the present invention is to provide a pet chew toy that when the pet eats the pet chew toy, its teeth is cleaned and becomes strong by using a chewing tenacity of and suitable friction of the cowskin layers to prevent bacterium from multiplication, having healthful teeth.

Fifth object of the present invention is to provide a pet chew toy that includes the fluidic ground meat with the granule-shaped meat balls to enhance chewing elasticity and mouthfeel.

Sixth object of the present invention is to provide a pet chew toy that is capable of simplifying manufacture process and lowering production cost.

Another object of the present invention is to provide a pet chew toy that is capable of presenting variety.

To obtain the above objectives, a pet chew toy provided by the present invention contains:

a body including a cowskin layer rolled and having an external fill space and an internal fill space;

a filing member including a fluidic ground meat with a number of granule-shaped meat balls, characterized in that:

the external fill space of the body includes the fluidic ground meat filled therein.

### BRIEF DESCRIPTION OF THE DRAWINGS

FIG. 1 is a perspective view showing the assembly of a pet chew toy according to a first embodiment of the present invention;

FIG. 2 is a cross sectional view showing the assembly of a pet chew toy according to the first embodiment of the present invention;

FIG. 3 is a perspective view showing the assembly of a pet chew toy according to a second embodiment of the present invention;

FIG. 4 is a cross sectional view showing the assembly of a pet chew toy according to the second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

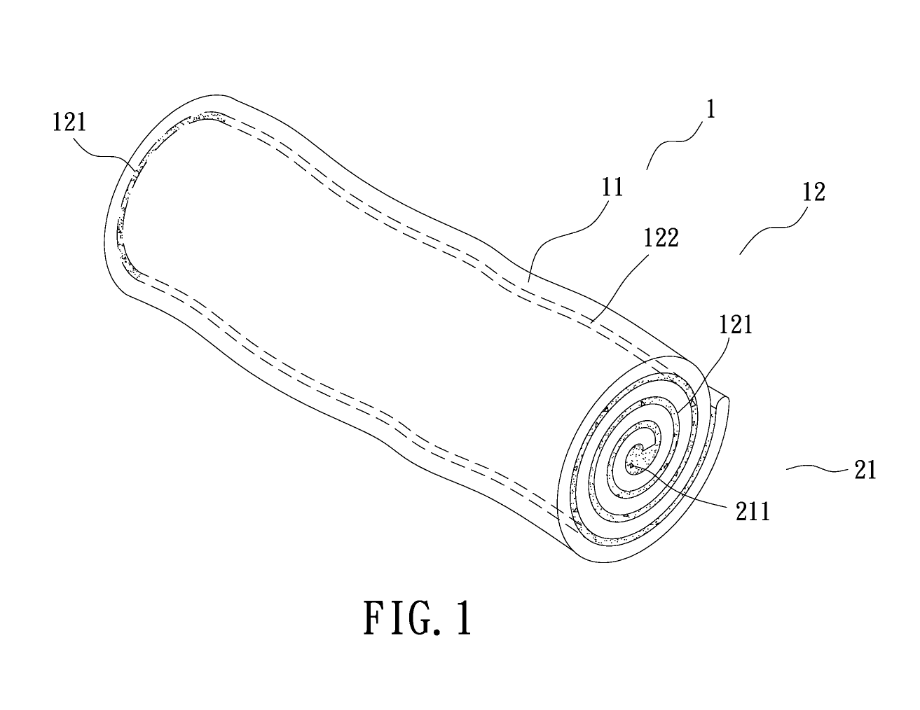

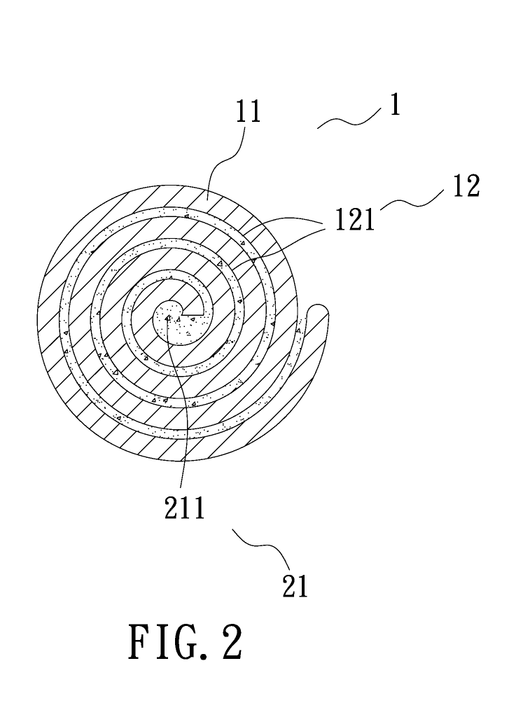

With reference to FIGS. 1-2, a pet chew toy according to a first embodiment of the present invention comprises a body 1 and a filing member 2, wherein

the body 1 includes a cowskin layer 11 rolled and having an external fill space 121 and an internal fill space 122, a profile of the body 1 is a trunk with a plurality of circular rings, and between each two circular rings is spaced apart by a stuffing space 12;

the filing member 2 includes a fluidic ground meat 21 with a number of granule-shaped meat balls 211, characterized in that:

the external fill space 121 of the body 1 includes the fluidic ground meat 21 filled or applied therein.

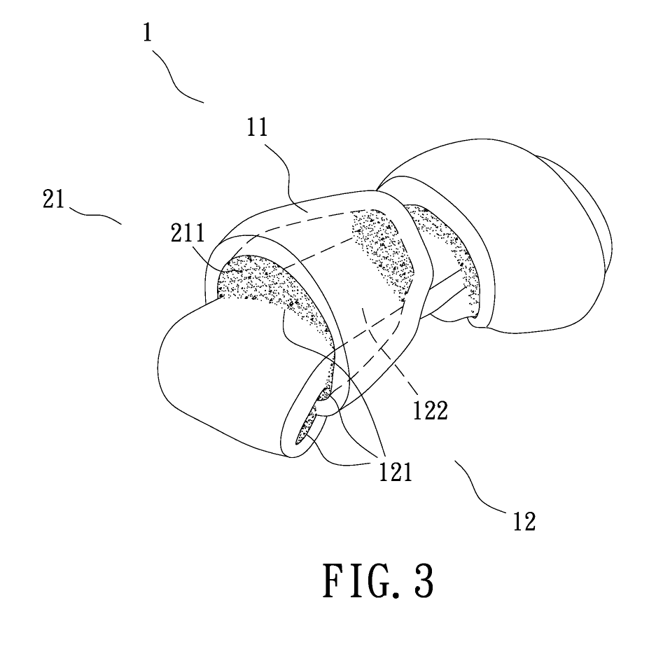

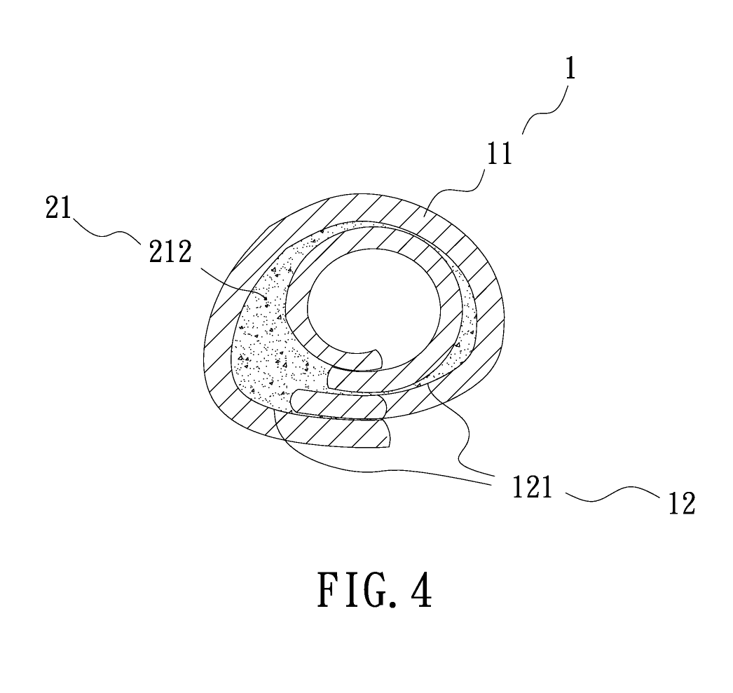

Referring to FIGS. 3 and 4, a pet chew toy according to a second embodiment of the present invention comprises a body 1 and a filing member 2, wherein

the body 1 includes a cowskin layer 11 rolled and having an external fill space 121 and an internal fill space 122, a profile of the body 1 is a bone with a plurality of cross rooms, and between each two cross rooms is spaced apart by a stuffing space 12, and the stuffing space 12 is an independent spacing structure;

the filing member 2 includes a fluidic ground meat 21 with a number of granule-shaped meat balls 211, characterized in that:

the external fill space 121 of the body 1 includes the fluidic ground meat 21 filled or applied therein.

The fluidic ground meats 21 covered on the cowskin layers 11 of the first and the second embodiments are capable of attracting and inducing the sense of smell of the pet so that when the pet eats the pet chew toy, its teeth is cleaned and becomes strong by using a chewing tenacity of and suitable friction of the cowskin layers 11.

While we have shown and described various embodiments in accordance with the present invention, it is clear to those skilled in the art that further embodiments may be made without departing from the scope of the present invention.

What is claimed:

1. A pet chew toy comprising:
a body including a cowskin layer rolled and having an external fill space and an internal fill space;
a filing member including a fluidic ground meat with a number of granule-shaped meat balls, characterized in that:
the external fill space of the body includes the fluidic ground meat filled therein.

2. A pet chew toy comprising:
a body including a cowskin layer rolled and having an external fill space and an internal fill space;
a filing member including a fluidic ground meat with a number of granule-shaped meat balls, characterized in that:
the external fill space of the body includes the fluidic ground meat applied therein.
